(19) United States
(12) Patent Application Publication
(10) Pub. No.: US 2009/0168015 A1
(43) Pub. Date: Jul. 2, 2009

(54) METHOD FOR PROVIDING DUAL SURFACE PROGRESSIVE ADDITION LENS SERIES

(75) Inventors: C. Benjamin Wooley, Jacksonville, FL (US); Pierre Gerligand, Jacksonville, FL (US); Jing Wang, Arden Hills, MN (US); Shyamy Sastry, Roanoke, VA (US); James S. Merritt, Lebanon, OH (US)

Correspondence Address: OCCHIUTI ROHLICEK & TSAO, LLP, 10 FAWCETT STREET, CAMBRIDGE, MA, 02138, US

(73) Assignee: Essilor International (Compagnie Generale D'Optique), Charenton Le Pont (FR)

(21) Appl. No.: 11/993,146

(22) PCT Filed: Jun. 19, 2006
(86) PCT No.: PCT/IB2006/002487

§ 371 Date: Dec. 29, 2008

Related U.S. Application Data
(60) Provisional application No. 60/692,085, filed on Jun. 20, 2005.

(51) Int. Cl. G02C 7/06

(52) U.S. Cl. 351/177; 351/169

(57) ABSTRACT

Designing spectacle lens blanks for a dual-surface progressive addition lens (PAL) comprising determining a prescription range from a first set of first designs to produce a second set of first designs satisfying the prescription range, determining a common surface using the second set of first designs, and using the common surface to produce a set of second designs satisfying the prescription range.

### TECHNICAL FIELD

The present invention relates to multifocal ophthalmic lenses. In particular, the invention provides methods for designing and manufacturing dual surface, progressive addition lenses.

### BACKGROUND

The use of ophthalmic lenses for the correction of ametropia is well known. For example, multifocal lenses, such as progressive addition lenses (“PALs”) are used for the treatment of presbyopia. PALs have at least one progressive surface that provides far, intermediate, and near vision in a gradual, continuous progression of vertically increasing dioptric power from far to near focus.

One type of PAL is a dual-surface PAL, or dual add, in which both the front and back surfaces are progressive surfaces. In conventional production methods, a lens blank, a first surface of which is a unique progressive design, is required for every add power. A second progressive surface is matched with every first surface to produce the lens. The first surfaces cannot be used other than with the specific second surface which they are matched and cannot be used to produce dual add lenses of alternative design.

### SUMMARY

In some aspects of the invention, a method for designing spectacle lens blanks for a dual-surface progressive addition lens (PAL) comprising determining a prescription range from a first set of first designs to produce a second set of first designs satisfying the prescription range, determining a common surface using the second set of first designs, and using the common surface to produce a set of second designs satisfying the prescription range.

In some embodiments, the designs may comprise channel lengths, hard or soft designs, power progressions through a channel below a near reference point, distance performance, intermediate performance and/or near performance.

In some embodiments, the designs may comprise methods for determining add powers, the add powers described by one or more of: front vertex adds, back vertex adds, effective adds, frame shape, frame size, design asymmetry, performance optimization based on lens thickness and prism, and measurable patient vision preferences.

In some embodiments, the design may comprise one or more base curves and/or one or more add powers. The more than one add power may have the same base curve. The more than one base curve may have the same add power. The add powers may be split between the front and back surfaces of the lens. The set of second design may be smaller than the second set of first designs. The design may be analyzed using ray-tracking analysis.

In some embodiments, one surface of the dual-surface progressive addition lens may be a progressive surface. One surface of the dual-surface progressive addition lens may be a spherical surface. Producing a set of second designs may be found using to the equation:

Second_memberⁱ_base^{j}_add^{k}=SSDe_memberⁱ_base^{j}_add^{k}−Common_First_base^{j}_add^{k}+Second_Spherical_memberⁱ_base^{j}_add^{k}

wherein Second_memberⁱ_base^{j}_add^{k} is the second surface for the i^{th} member;
SSDe_memberⁱ_base^{j}_add^{k} is the equivalent single surface design for the i^{th} member created from the design created in second step of the method of the invention;
Common_First_base^{j}_add^{k} I the common first surface designed created in the third step of the method of the invention; and Second_Spherical_memberⁱ_base^{j}_add^{k} is the spherical portion of Second_memberⁱ_base^{j}_add^{k}.

In some embodiments, determining whether the set of second design satisfying the prescription range may comprise an analysis of whether the performance of each lens of the Common_Firsti_basej_addk and Second_memberi_basej_addk is within the prescriptive range. The analysis may include ray-trace analysis of the lens in an “as-worn” position. The analysis may include a tolerance analysis of the performance of the common surface across the entire range of the set of second designs.

In some embodiments, the analysis may simulate the production of a large number of lenses with one or more manufacturing errors. The manufacturing errors may include surface tilt, surface decentration, and/or surface figure errors. Known statistical distributions may be applied to generate the manufacturing errors.

In some embodiments, if the set of second design is not within the prescription range, the steps of the method are repeated one or more times or until the set of second design is within the prescription range.

In some embodiments, if the set of second design is not within the prescription range, a Second_memberi_basej_addk may be optimized while the Common_First_basej_addk surfaces remain unchanged. The optimization may use ray-tracing in which the second surface is optimized in the as-worn position. Upon completion of the optimization, lens performance again is analyzed and, if performance again is found to be unsatisfactory, the preceding steps of the method may be repeated one or more times.

In some embodiments, lenses of the set of second design may be optimized using ray trace based optimization with each of the back surfaces. The optimization may use the following equation:

$$MF = {\sum }_{i}^{ } {\sum }_{x}^{ } {\sum }_{y}^{ } ⌊ \begin{matrix}w\_p {( x , y )}_{i} {( {P ( x , y )}_{i} - {Φ ( x , y )}_{i} )}^{2} + \\ w\_c {( x , y )}_{i} {( {C ( x , y )}_{i} - {cyl ( x , y )}_{i} )}^{2}\end{matrix} ⌋$$

wherein i is a member of the set of designs, x and y are points on the surface, Φ(x, y) is the power calculated at each point (x, y), P(x, y) is the target power value, cyl(x, y) is the cylinder calculated at each (x, y) point, C(x, y) is the cylinder targets, w_p(x, y) is the power weight; and w_c(x, y) is the cylinder weight. C(x, y) and cyl(x, y) may be replaced with other lens performance measures. The lens performance measure may include RMS (root mean square) spot size. The optimization variables may include variables that control the first common surface and variables that control the second surface for each member i of the set of second designs. The common surface may be a surface not in either the first set of first designs or the second set of first designs. The common surface may be determined according to the following equation:

Common_First_base^{j}_add^{k}=average(SSDs_member¹_base^{j}_add^{k}+SSDs_member².base^{j}_add^{k}+ . . . )

wherein the average is an average surface sag value for each member of the designated base curve and add power. The average surface sag value may be a point-by-point surface sag average. In some embodiments, the common surface may be a surface from the second set of first designs.

The invention also relates to the production of a spectacle lens blanks for a dual-surface progressive addition lens (PAL) designed comprising determining a prescription range from a first set of first designs to produce a second set of first designs satisfying the prescription range, determining a common surface using the second set of first designs, and using the common surface to produce a set of second designs satisfying the prescription range.

The details of one or more embodiments of the invention are set forth in the accompanying drawings and the description below. Other features, objects, and advantages of the invention will be apparent from the description and drawings, and from the claims.

### DETAILED DESCRIPTION

The present invention provides efficient methods for the design and manufacture of progressive addition lenses. The method of the invention permits creation of a set of first surfaces which may be used to produce progressive addition lenses, such as dual add lenses, of varying design. For example, the method of the invention may be used to provide one or more of a range of channel lengths, hard and soft designs, alternate design choices with various power progressions through the channel below the near reference point, alternative design choices for intermediate, distance and near vision performance, alternative choices as to how add power is determined to include lens add given by the front vertex, back vertex and effective adds, frame shape and size, design asymmetry, performance optimization based on lens thickness and prism, and measurable patient vision preferences. Additionally, the first set of surfaces are designed so that one surface covers a range of add powers thereby decreasing the number of lens blanks necessary to produce the lenses.

For purposes of the invention, by “progressive addition surface” or “progressive surface” is meant a continuous, aspheric surface having distance and near viewing zones, and a zone of increasing dioptric power connecting the distance and near zones. One ordinarily skilled in the art will recognize that, if the progressive surface is the convex surface of the lens, the distance vision zone curvature will be less than that of the near zone curvature and if the progressive surface is the lens' concave surface, the distance curvature will be greater than that of the near zone.

By “progressive addition surface” or “progressive surface” is meant a continuous, aspheric surface having distance and near viewing zones, and a zone of increasing dioptric power connecting the distance and near zones. One ordinarily skilled in the art will recognize that, if the progressive surface is the convex surface of the lens, the distance vision zone curvature will be less than that of the near zone curvature and if the progressive surface is the lens' concave surface, the distance curvature will be greater than that of the near zone.

By “channel” is meant a corridor of vision the width of which is the area of vision that is free of unwanted astigmatism. When the wearer's eye is scanning through the intermediate vision zone to the near vision zone and back, the length is the area between the fitting point and the point along the prime meridian of the lens at which the power reaches 85% of the lens' add power.

In the first step of the method of the invention, a plurality of base curves and add powers are selected for a first set of progressive surfaces. In conventional methods, six base curves typically would be provided for each add power. However, in the method of the invention, and as exemplified in Table 1, the same base curve is provided for more than one add power. The same add power can be provided by more than one base curve.

By “base curves” is meant the aspects describing the curvature present in each point of the surface design. The design is a combination of base curves. Base curves can be a described by a radius of curvature for each coordinate (x, y).

TABLE 1

| | |
|---|---|
| Front Surface 1 | Add powers: 1; 1.25; 1.5 diopters |
| | Sphere powers: −5 to −10 diopters |
| Front Surface 2 | Add powers: 1; 1.25; 1.5 diopters |
| | Sphere powers: −1 to −4.75 diopters |
| Front Surface 3 | Add powers: 1; 1.25; 1.5 diopters |
| | Sphere powers: 2 to −0.75 diopters |
| Front Surface 4 | Add powers: 1; 1.25; 1.5 diopters |
| | Sphere powers: 4 to 2.25 diopters |
| Front Surface 5 | Add powers: 1; 1.25; 1.5 diopters |
| | Sphere powers: 6 to 3.75 diopters |
| Front Surface 6 | Add powers: 1; 1.25; 1.5 diopters |
| | Sphere powers: 8 to 6.25 diopters |
| Front Surface 7 | Add powers: 1.75, 2, 2.25 diopters |
| | Sphere powers: −5 to −10 diopters |
| Front Surface 8 | Add powers: 1.75, 2, 2.25 diopters |
| | Sphere powers: −1 to −4.75 diopters |
| Front Surface 9 | Add powers: 1.75, 2, 2.25 diopters |
| | Sphere powers: 2 to −0.75 diopters |
| Front Surface 10 | Add powers: 1.75, 2, 2.25 diopters |
| | Sphere powers: 4 to 2.25 diopters |
| Front Surface 11 | Add powers: 1.75, 2, 2.25 diopters |
| | Sphere powers: 6 to 3.75 diopters |
| Front Surface 12 | Add powers: 1.75, 2, 2.25 diopters |
| | Sphere powers: 8 to 6.75 diopters |
| Front Surface 13 | Add powers: 2.5, 2.75, 3 diopters |
| | Sphere powers: −5 to −10 diopters |
| Front Surface 14 | Add powers: 2.5, 2.75, 3 diopters |
| | Sphere powers: −1 to −4.75 diopters |
| Front Surface 15 | Add powers: 2.5, 2.75, 3 diopters |
| | Sphere powers: 2 to −0.75 diopters |
| Front Surface 16 | Add powers: 2.5, 2.75, 3 diopters |
| | Sphere powers: 4 to 2.25 diopters |
| Front Surface 17 | Add powers: 2.5, 2.75, 3 diopters |
| | Sphere powers: 6 to 3.75 diopters |
| Front Surface 18 | Add powers: 2.5, 2.75, 3 diopters |
| | Sphere powers: 8 to 6.25 diopters |

The add power that is applied to the front and back surfaces to give the total prescribed add power for a dual add design is split between the front and back surfaces. In the method of the invention, the split need not be constant by base curve or by add power, as exemplified in Table 2 where one possibility for the add power split between the front and back for the 18 surfaces shown in Table 1 is given.

TABLE 2

| | 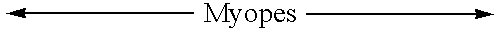 | | | | 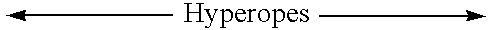 | | | | | | | |
|---|---|---|---|---|---|---|---|---|---|---|---|---|
| Rx | 2.00D Base Power | | 3.50D Base Power | | 5.00D Base Power | | 6.5D Base Power | | 7.75D Bass Power | | 8.75D Base Power | |
| Add | Front Add | Back Add | Front Add | Back Add | Front Add | Back Add | Front Add | Back Add | Front Add | Back Add | Front Add | Back Add |
| 1 | 0.2 | 0.8 | 0.3 | 0.7 | 0.4 | 0.6 | 0.5 | 0.5 | 0.6 | 0.4 | 0.7 | 0.3 |
| 1.25 | 0.2 | 1.05 | 0.3 | 0.95 | 0.4 | 0.85 | 0.5 | 0.75 | 0.6 | 0.65 | 0.7 | 0.55 |
| 1.5 | 0.2 | 1.3 | 0.3 | 1.2 | 0.4 | 1.1 | 0.5 | 1 | 0.6 | 0.9 | 0.7 | 0.8 |
| 1.75 | 0.7 | 1.05 | 0.8 | 0.95 | 0.9 | 0.85 | 1 | 0.75 | 1.1 | 0.65 | 1.2 | 0.55 |
| 2 | 0.7 | 1.3 | 0.8 | 1.2 | 0.9 | 1.1 | 1 | 1 | 1.1 | 0.9 | 1.2 | 0.8 |
| 2.25 | 0.7 | 1.55 | 0.8 | 1.45 | 0.9 | 1.35 | 1 | 1.25 | 1.1 | 1.15 | 1.2 | 1.05 |
| 2.5 | 1.2 | 1.3 | 1.3 | 1.2 | 1.4 | 1.1 | 1.5 | 1 | 1.6 | 0.9 | 1.7 | 0.8 |
| 2.75 | 1.2 | 1.55 | 1.3 | 1.45 | 1.4 | 1.35 | 1.5 | 1.25 | 1.6 | 1.15 | 1.7 | 1.05 |
| 3 | 1.2 | 1.8 | 1.3 | 1.7 | 1.4 | 1.6 | 1.5 | 1.5 | 1.6 | 1.4 | 1.7 | 1.3 |

As illustrated in Table 2, a large number of blanks are required to accommodate a given prescription range. For example, to cover myope prescriptions with an add power range from 1 to 1.5, three blanks are required: one with a front add of 0.2 and a back add of 0.8, one with a front add of 0.2 and a back add of 1.05, and one with a front add of 0.2 and a back add of 1.3. Subsequently, to cover add power ranges from 1 to 3 and base power range of 2 to 8.75, 54 blanks are required. This is number is further increased by the need for left and right lens distinctions.

The following method reduces the number of blanks necessary to cover these prescription ranges. Using the base curves and add powers selected in the first step of the method, each lens in a set of lenses covering a desired prescriptive range is provided using any known design method as, for example, in U.S. Pat. No. 6,302,540 and U.S. application Ser. No. 10/606,391 incorporated herein in their entireties by reference. In the exemplary case of a dual add lens, each lens provided will have a unique design for each base curve and add power and may be designated as:

Dual_memberⁱ_base^{j}_add^{k}

wherein:
i is a member of the set of lenses;
j is a base curve; and
k is an add power.
   Alternatively, if the lens is a progressive lens in which only one surface is a progressive surface, each lens will be designated as:

SSD_memberⁱ_base^{j}_add^{k}

wherein:
i is a member of the set of lenses;
j is a base curve; and
k is an add power.
   Each of the individual lens designs then may be analyzed for performance using any convenient method as, for example, ray-tracing analysis.

In the third step of the invention, a surface is selected from among the lenses created in the preceding step for each base curve j and add power k. This surface will be used as a common surface for each base curve and add power selected in the first step of the method of the invention.

A plurality of second surfaces to be used with the common surface is then created. Any suitable design method may be used for creation of the second surface. For example, in the case in which the lens will be a dual add lens, the assumptions may be made that, for every dual surface lens, there is an equivalent lens one surface of which is a progressive surface and one surface of which is a spherical surface. This equivalent lens may be found by any known method including, without limitation, sag addition or the method disclosed in U.S. application Ser. No. 10/870,080 incorporated herein in their entireties by reference. The equivalent surface may be designated as:

SSDe_memberⁱ_base^{j}_add^{k}

wherein:
i is a member of the set of lenses;
j is a base curve; and
k is an add power.

By “sag addition” is meant that two surfaces can be added such that the resulting point is the sum of the corresponding points of the two surfaces. Said differently, “z(x, y) of surface 3”=“z(x, y) of surface 1”+“z(x, y) of surface 2”.

The second surface to be created is then found using the following equation:

Second_memberⁱ_based^{j}_add^{k}=SSDe_memberⁱ_base^{j}_add^{k}−Common_First_base^{j}_add^{k}+Second_Spherical_memberⁱ_base^{j}_add^{k}

wherein:
Second_memberⁱ_base^{j}_add^{k} is the second surface for the i^{th} member;
SSDe_memberⁱ_base^{j}_add^{k} is the equivalent single surface design for the i^{th} member created from the design created in second step of the method of the invention;
Common_First_base^{j}_add^{k} I the common first surface designed created in the third step of the method of the invention; and
Second_Spherical_memberⁱ_base^{j}_add^{k} is the spherical portion of
Second_memberⁱ_base^{j}_add^{k}.

To continue the previous example, the goal is to reduce the three designs to one design for the front. A design is designated or, in some cases, generated to produce the common design. Next, a second surface is created to be used with the common front. This second surface and the common front together produce a single lens blank.

In the next step of the method of the invention, the performance of each lens of the Common_Firstⁱ_base^{j}_add^{k} and Second_memberⁱ_base^{j}_add^{k} within the full prescriptive range is analyzed. Preferably, the analysis is carried out using ray-trace analysis of the lens in the “as-worn” position. More preferably, the analysis includes a tolerance analysis to ensure that the common first surface performs satisfactorily across the entire range of the second surface designs. Preferably, this analysis is carried out simulating the production of a large number of lenses with the manufacturing errors including, without limitation, surface tilt, surface decentration, and surface figure errors, applied according to known statistical distributions. This analysis is then compared with the analysis carried out for the designs created in the second step of the method of the invention in order to determine that each lens across the prescriptive range performs satisfactorily using the set of common first surfaces.

If the analysis demonstrates that the lenses' performance is not satisfactory, the steps of the method may be repeated until a satisfactory performance result is obtained. Alternatively, the second surface, or Second_memberⁱ_base^{j}_add^{k}, may be optimized while the Common_First_base^{j}_add^{k} surfaces remain unchanged. Preferably, the optimization is carried out via ray-tracing in which the second surface is optimized in the as-worn position. Once the optimization is completed, lens performance again is analyzed and, if performance again is found to be unsatisfactory, the preceding steps of the method may be repeated.

To continue the example, in the case of myope prescriptions with an add power range from 1 to 1.5, the three bank designs are analyzed. A common surface is generated using these three surfaces with the goal of producing a second surface capable of accommodating the entire add range of 1 to 1.5. The common surface can be the surface that originally accommodated the base power of 2 with a front add of 0.2 and a back add of 1.05. The common surface also can be a surface that is not one of the original three. Once a common surface is generated (or selected in some cases), the common surface is used to generate a second surface capable of accommodating the entire add range of 1 to 1.5. The base curves of the second surface are optimized to accommodate the range. Because this second surface is capable of accommodating the entire add range originally requiring three add blanks, the number of blanks required to cover various prescription ranges is reduced.

Alternatively, the common surface may be optimized using ray trace based optimization with each of the back surfaces. The set of lenses may be simultaneously optimized by using the following equation (merit function):

$$MF = {\sum }_{i}^{ } {\sum }_{x}^{ } {\sum }_{y}^{ } ⌊ \begin{matrix}w\_p {( x , y )}_{i} {( {P ( x , y )}_{i} - {Φ ( x , y )}_{i} )}^{2} + \\ w\_c {( x , y )}_{i} {( {C ( x , y )}_{i} - {cyl ( x , y )}_{i} )}^{2}\end{matrix} ⌋$$

wherein:
i is a member of the set of designs;
x and y are points on the surface;
Φ(x, y) is the power calculated at each point (x, y);
P(x, y) is the target power value;
cyl(x, y) is the cylinder calculated at each (x, y) point;
C(x, y) is the cylinder targets;
w_p(x, y) is the power weight; and
w_c(x, y) is the cylinder weight.
C(x, y) and cyl(x, y) may be replaced with other lens performance measures including, without limitation, RMS (root mean square) spot size. The optimization variables include those that control the first common surface and the second surface for each member i of the set of designs.

As an alternative for carrying out the third step of the method of the invention, the common first surface may be a surface that is created. For example, if the lenses within the set created in the second step of the method are dual add lenses, then a set of single progressive surface lenses equivalent to the set of dual add lenses may be created. For each lens in the original set of dual add lenses, there is now an SSDe, or equivalent design file, corresponding to the base curves selected in the first step if the method and each of the add power of the lenses is scaled to be the add power selected in the first step giving SSDs_memberⁱ_base^{j}_add^{k}. The common surface is then determined according to the following equation:

Common_First_base^{j}_add^{k}=average(SSDs_member¹_base^{j}_add^{k}+SSDs_member².base^{j}_add^{k}+ . . . )

The average is the average surface sag value, point-by-point, for each member for the designated base curve and add power.

A number of embodiments of the invention have been described. Nevertheless, it will be understood that various modifications may be made without departing from the spirit and scope of the invention. Accordingly, other embodiments are within the scope of the following claims.

What is claimed is:

1. A method for designing spectacle lens blanks for a dual-surface progressive addition lens (PAL) comprising determining a prescription range from a first set of first designs to produce a second set of first designs satisfying the prescription range, determining a common surface using the second set of first designs, and using the common surface to produce a set of second designs satisfying the prescription range.

2. The method of claim 1 wherein the first designs comprise channel lengths.

3. The method of claim 1 wherein the first designs comprise hard or soft designs.

4. The method of claim 1 wherein the first designs comprise power progressions through a channel below a near reference point.

5. The method of claim 1 wherein the first designs comprise one or more of: distance performance; intermediate performance; and near performance.

6. The method of claim 1 wherein the first designs comprise methods for determining add powers, the add powers described by one or more of: front vertex adds, back vertex adds, effective adds, frame shape, frame size, design asymmetry, performance optimization based on lens thickness and prism, and measurable patient vision preferences.

7. The method of claim 1 wherein the first design comprises one or more base curves and/or one or more add powers.

8. The method of claim 7 wherein the more than one add power has the same base curve.

9. The method of claim 7 wherein the more than one base curve has the same add power.

10. The method of claim 7 wherein the add powers are split between the front and back surfaces of the lens.

11. The method of claim 1 wherein the set of second design is smaller than the second set of first designs.

12. The method of claim 1 wherein the first designs are analyzed using ray-tracking analysis.

13. The method of claim 1 wherein one surface of the dual-surface progressive addition lens is a progressive surface.

14. The method of claim 1 wherein one surface of the dual-surface progressive addition lens is a spherical surface.

15. The method of claim 1 wherein producing a set of second designs if found using to the following equation:
Second_memberⁱ_base^{j}_add^{k}=SSDe_memberⁱ_base^{j}_add^{k}−Common_First_base^{j}_add^{k}+Second_Spherical_memberⁱ_base^{j}_add^{k}
wherein:
Second_memberⁱ_base^{j}_add^{k} is the second surface for the i^{th} member;
SSDe_memberⁱ_base^{j}_add^{k} is the equivalent single surface design for the i^{th} member created from the design created in second step of the method of the invention;
Common_First_base^{j}_add^{k} I the common first surface designed created in the third step of the method of the invention; and
Second_Spherical_memberⁱ_base^{j}_add^{k} is the spherical portion of
Second_memberⁱ_base^{j}_add^{k}.

16. The method of claim 1 wherein determining whether the set of second design satisfying the prescription range comprises an analysis of whether the performance of each lens of the Common_Firsti_basej_addk and Second_memberi_basej_addk is within the prescriptive range.

17. The method of claim 16 wherein the analysis includes ray-trace analysis of the lens in an “as-worn” position.

18. The method of claim 16 wherein the analysis includes a tolerance analysis of the performance of the common surface across the entire range of the set of second designs.

19. The method of claim 16 wherein the analysis simulates the production of a large number of lenses with one or more manufacturing errors.

20. The method of claim 19 wherein the manufacturing errors include one or more of: surface tilt; surface decentration; and surface figure errors.

21. The method of claim 19 wherein the manufacturing errors are applied according to known statistical distributions.

22. The method of claim 16 wherein if the set of second design is not within the prescription range, the steps of the method is repeated one or more times or until the set of second design is within the prescription range.

23. The method of claim 16 wherein if the set of second design is not within the prescription range, a Second_memberi_basej_addk is optimized while the Common_First_basej_addk surfaces remain unchanged.

24. The method of claim 23 wherein the optimization uses ray-tracing in which the second surface is optimized in the as-worn position.

25. The method of claim 23 wherein upon completion of the optimization, lens performance again is analyzed and, if performance again is found to be unsatisfactory, the preceding steps of the method is repeated one or more times.

26. The method of claim 1 wherein lenses of the set of second design is optimized using ray trace based optimization with each of the back surfaces.

27. The method of claim 26 wherein the optimization uses the following equation:
$$MF = {\sum }_{i}^{ } {\sum }_{x}^{ } {\sum }_{y}^{ } ⌊ \begin{matrix}w\_p {( x , y )}_{i} {( {P ( x , y )}_{i} - {Φ ( x , y )}_{i} )}^{2} + \\ w\_c {( x , y )}_{i} {( {C ( x , y )}_{i} - {cyl ( x , y )}_{i} )}^{2}\end{matrix} ⌋$$
wherein:
i is a member of the set of designs;
x and y are points on the surface;
Φ(x, y) is the power calculated at each point (x, y);
P(x, y) is the target power value;
cyl(x, y) is the cylinder calculated at each (x, y) point;
C(x, y) is the cylinder targets;
w_p(x, y) is the power weight; and
w_c(x, y) is the cylinder weight.

28. The method of claim 27 wherein C(x, y) and cyl(x, y) is replaced with other lens performance measures.

29. The method of claim 28 wherein the lens performance measure includes RMS spot size.

30. The method of claim 26 wherein the optimization variables include variables that control the first common surface and variables that control the second surface for each member i of the set of second designs.

31. The method of claim 1 wherein the common surface is a surface not in either the first set of first designs or the second set of first designs.

32. The method of claim 31 wherein the common surface is determined according to the following equation:
Common_First_base^{j}_add^{k}=average(SSDs_member¹_base^{j}_add^{k}+SSDs_member².base^{j}_add^{k}+ . . . )
wherein the average is an average surface sag value for each member of the designated base curve and add power.

33. The method of claim 32 wherein the average surface sag value is a point-by-point surface sag average.

34. The method of claim 1 wherein the common surface is a surface from the second set of first designs.

35. A spectacle lens blanks for a dual-surface progressive addition lens (PAL) designed comprising determining a prescription range from a first set of first designs to produce a second set of first designs satisfying the prescription range, determining a common surface using the second set of first designs, and using the common surface to produce a set of second designs satisfying the prescription range.
